(19) United States
(12) Patent Application Publication
(10) Pub. No.: US 2026/0317146 A1
(43) Pub. Date: Oct. 15, 2026

(54) INDUCED VORTEX FUNNEL

(71) Applicant: Great Neck Saw Manufacturers, Inc., Memphis, TN (US)

(72) Inventors: Jeffrey G. Karl, Rossville, TN (US); Grant Goodall, Memphis, TN (US)

(73) Assignee: Great Neck Saw Manufacturers, Inc., Memphis, TN (US)

(21) Appl. No.: 19/576,438

(22) Filed: Mar. 24, 2026

Related U.S. Application Data
(60) Provisional application No. 63/786,926, filed on Apr. 10, 2025.

(51) Int. Cl. B67C 11/02

(52) U.S. Cl. CPC B67C 11/02

(57) ABSTRACT

Described herein are a funnel and a method of forming a funnel and/or conduit of a funnel including an upper section including an inlet configured to receive a liquid. The funnel may include a lower section including a non-circular shaped outlet configured to expel the liquid. The funnel may also include a tapered spiral section extending between the upper section and the lower section which includes a spiral contour configured to rotate the liquid from the inlet to the non-circular shaped outlet.

### CROSS-REFERENCES TO RELATED APPLICATIONS

The present application claims priority to U.S. Provisional Application No. 63/786,926 filed on Apr. 10, 2025, entitled Induced Vortex Funnel, the entire disclosure of which is incorporated by reference herein.

### TECHNICAL FIELD

Embodiments of the present disclosure are directed to fluid funneling devices. More particularly, the present disclosure describes an induced vortex funnel.

### BACKGROUND

Funnels are widely used tools for directing liquids into containers with narrow openings, yet they present numerous challenges that hinder their effectiveness and ease of use. One significant problem with traditional funnels is the difficulty in controlling flow rates, particularly when transferring liquids with varying viscosities. The lack of precision in flow control can lead to spills, overflows, or inefficient filling processes, especially when working with small or delicate containers. The viscosity of fluids can cause slow pouring so the size of the funnel is paramount to operations. Additionally, sizes of funnels often fail to accommodate a wide range of container openings, necessitating the use of multiple funnels or adapters for different tasks, which can be inconvenient and inefficient.

Another issue is the awkward shapes and designs of many funnels, which can make them difficult to hold or stabilize during use. This is particularly problematic when pouring liquids from heavy or unwieldy source containers, as users often need to balance the funnel while ensuring proper alignment with the receiving container. Such instability increases the risk of accidents, spills, and user frustration. Furthermore, conventional funnels often lack ergonomic features, such as non-slip grips or easy to use surfaces, that could enhance ease of use and versatility.

While alternatives such as spouts or pour-over devices exist, these solutions are often limited and cannot fully replace the functionality of a funnel. Spouts, for instance, lack the universal adaptability of a standalone funnel. Pour-over devices, on the other hand, are typically designed for specialized tasks, such as brewing coffee, and are unsuitable for general liquid transfer applications. These limitations underscore the need for an improved funnel design that addresses issues of flow control, size adaptability, and ergonomic stability, while maintaining the versatility required for a range of uses.

### BRIEF DESCRIPTION OF FIGURES

FIG. 1 is a perspective view of an example induced vortex funnel, in accordance with various embodiments of the present disclosure;

FIG. 2 is a front view of an example induced vortex funnel, in accordance with various embodiments of the present disclosure;

FIG. 3 is a rear view of an example induced vortex funnel, in accordance with various embodiments of the present disclosure;

FIG. 4 is a right side view of an example induced vortex funnel, in accordance with various embodiments of the present disclosure;

FIG. 5 is a left side view of an example induced vortex funnel, in accordance with various embodiments of the present disclosure;

FIG. 6A is a top-down view of an example induced vortex funnel, in accordance with various embodiments of the present disclosure;

FIG. 6B is a bottom-up view of an example induced vortex funnel, in accordance with various embodiments of the present disclosure;

FIG. 7A depicts a configuration of an example induced vortex funnel, in accordance with various embodiments of the present disclosure;

FIG. 7B depicts a configuration for an example induced vortex funnel, in accordance with various embodiments of the present disclosure;

FIG. 8A depicts a configuration for an example gripping surface for an induced vortex funnel 800, in accordance with various embodiments of the present disclosure;

FIG. 8B depicts a configuration for an example gripping surface for an induced vortex funnel, in accordance with various embodiments of the present disclosure;

FIG. 9A depicts a configuration of an example induced vortex funnel, in accordance with various embodiments of the present disclosure;

FIG. 9B depicts a configuration of an example induced vortex funnel, in accordance with various embodiments of the present disclosure;

FIG. 10 depicts a configuration for an example induced vortex funnel, in accordance with various embodiments of the present disclosure;

FIG. 11 depicts a configuration for a non-circular shaped outlet of an example induced vortex funnel, in accordance with various embodiments of the present disclosure;

FIG. 12 depicts a configuration for ribs of an example induced vortex funnel, in accordance with various embodiments of the present disclosure;

FIG. 13 depicts a configuration for a contoured indentation of an example induced vortex funnel, in accordance with various embodiments of the present disclosure;

FIG. 14A depicts a configuration for a protruding lip of an example induced vortex funnel, in accordance with various embodiments of the present disclosure;

FIG. 14B depicts a configuration for a protruding lip of an example induced vortex funnel, in accordance with various embodiments of the present disclosure;

FIG. 15 depicts a configuration for a parting line of an example induced vortex funnel, in accordance with various embodiments of the present disclosure;

FIG. 16A depicts a cross-section stacked example induced vortex funnels, in accordance with various embodiments of the present disclosure;

FIG. 16B depicts an external view for stacking example induced vortex funnels, in accordance with various embodiments of the present disclosure; and

FIG. 17 depicts an example method for forming funnels, in accordance with various embodiments of the present disclosure.

### DETAILED DESCRIPTION

Funnels, though important for transferring liquids into containers with narrow openings, often reveal significant shortcomings that hinder their efficiency and user-friendliness. A frequent difficulty arises in controlling the flow rate of liquids, particularly when precision is needed or when working with substances of varying viscosities. Spills, overflows, and wasted materials are common, highlighting the limitations of traditional funnel designs. These issues become especially pronounced in settings demanding accuracy, such as laboratories, kitchens, or industrial applications.

Another challenge stems from the incompatibility of funnels with the diverse range of container sizes encountered in everyday use. Standard funnels are often either too large or too small for the task at hand, forcing users to rely on multiple funnels or makeshift solutions, which adds unnecessary complexity and inconvenience. Compounding these problems is the physical design of many funnels, which can be awkward to hold and stabilize, particularly when handling heavy or unwieldy source containers. The lack of ergonomic features like grips further exacerbates user frustration, increasing the likelihood of spills and accidents on top of slow flow rates do to unoptimized flow conduits.

Despite the availability of alternatives like spouts and pour-over devices, these tools often fail to meet the broad adaptability and universal functionality expected of funnels. The persistence of these issues underscores the need for a funnel with improved flow design to address these challenges and improve the overall user experience.

To overcome these challenges, an induced vortex funnel of this disclosure provides performance and usability. By optimizing a funnel geometry, the induced vortex funnel may achieve a significant increase in flow rate (e.g., between twenty and forty percent faster than conventional funnels) while maintaining precision and minimizing turbulence by allowing airflow to return around the outlet along an exterior of the funnel. Additionally, a tapered spiral section may reduce static friction and adhesion by promoting kinetic fluid movement thus enabling smoother transfer of both low-viscosity and high-viscosity liquids out of an outlet. The spiral contour may include a cross-section similar to that of a Reuleaux triangle which spirals (e.g., helically) as a function of height between a frustoconical upper section inlet and a lower Reuleaux shaped triangular section. The frustoconical upper section may have a greater diameter than the Reuleaux shaped triangular lower section. The funnel may also have a parting line along the outside which allows funnels to be stacked without compaction that would make it difficult for users to remove funnels from one another. The parting line may enable ease of removal of funnels from the stacks.

In addition, ergonomic improvements are provided herein through the inclusion of non-slip grips and an angled (or flared) handle, ensuring stability and ease of use, even when working with heavy containers or in wet conditions. The lightweight yet durable construction improves weight distribution, reducing user strain during extended use. To further enhance practicality, the funnel features a stackable, modular design with protrusions that support additional induced vortex funnels, allowing for compact storage in commercial environments and adaptability to a wide range of container sizes.

As used herein, a “spiral contour” refers to a three-dimensional helical or spiral path defined by an inner surface of a tapered spiral section that imparts a vortical motion to liquid traveling from the inlet toward the outlet. “Rotation,” in this context, refers to a cumulative angular displacement of the liquid streamline about a central longitudinal axis of the funnel as induced by the spiral contour and/or any ribs.

It is expressly contemplated that, while a “funnel” is described herein for purposes of illustration, the structures, features, and methods disclosed are equally applicable to any suitable “conduit,” including but not limited to channels, ducts, tubes, pipes, or passageways adapted to direct, convey, or manage the flow of fluids, solids, or other materials. Unless otherwise specified, all references to a “funnel” should be understood as encompassing any conduit or equivalent structure capable of performing a similar function, regardless of its specific shape, size, configuration, or intended application. The disclosure is not intended to be limited to funnel embodiments, but rather is intended to broadly cover all suitable conduits within the scope of fluid direction control.

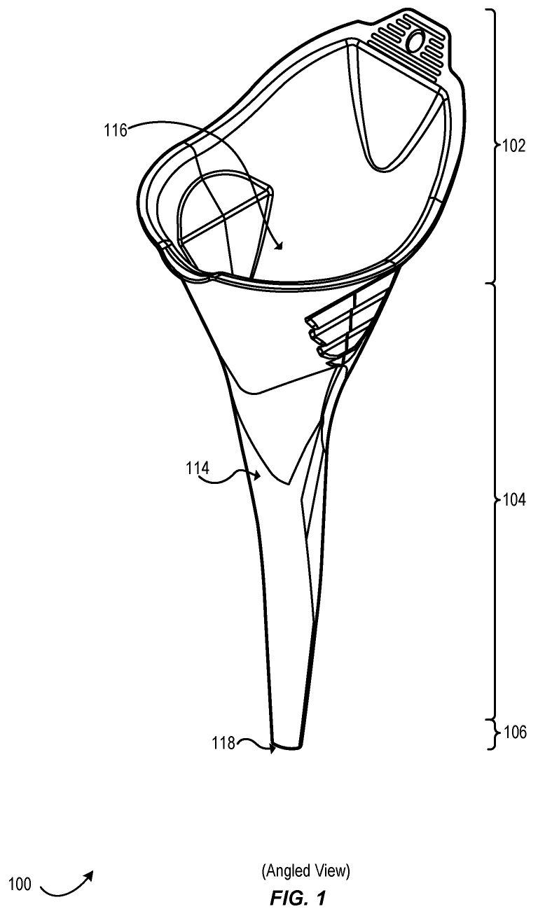

FIG. 1 is a perspective view of an example induced vortex funnel 100, in accordance with various embodiments of the present disclosure. The induced vortex funnel 100 may include, for example, three sections generally defined as an upper section 102, a tapered spiral section 104, and a lower section 106. While the tapered spiral section 104 is shown separate from the upper section 102 and the lower section 106 it should not be considered limiting, and the tapered spiral section 104 may include one or both of the upper section 102 and the lower section 106. The upper section 102 may include a frustoconical shape.

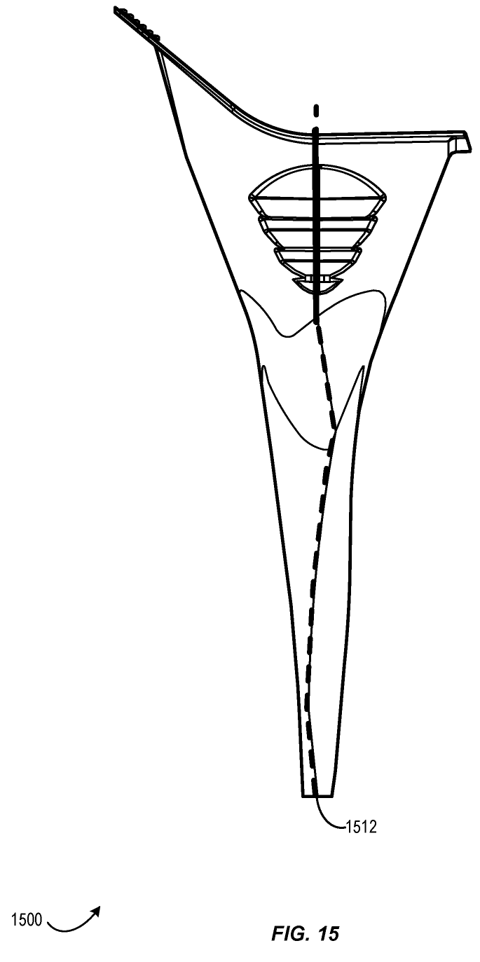

The induced vortex funnel 100 may be unitary (e.g., cast mold, 3D printed, etc.) or may be formed of multiple components combined together (as discussed in more detail with respect to FIG. 15). The upper section 102 may include an inlet 116 that can receive a liquid (e.g., water, oil, etc.). The tapered spiral section 104 (e.g., a connecting body that connects the upper section to the lower section) may include a spiral 114 from the upper section 102 to the lower section 106. In a non-limiting example, and relative to the upper section 102, the spiral 114 may include rotations from zero to plus or minus one thousand and eighty degrees or more depending on desired fluid flow characteristics. The lower section 106 may end at an outlet 118 (e.g., a non-circular outlet) which may receive fluid which has undergone a vortex motion by way of geometric properties relating to the spiral 114 and expel the fluid out of the induced vortex funnel 100. The outlet 118, and/or some or all of the lower section 106, may be shaped to provide surface which does not mate with inlets of receiving containers. For example, for receiving containers having a circular inlet such as gas containers, the outlet 118 and/or some or all of the lower section 106 may not be circular (e.g., spiraled) so that when the outlet 118 and/or some or all of the lower section 106 come in contact with the circular inlet, the dissimilar geometries may allow air to flow out from the receiving container along an exterior of the funnel 100 while fluid from within the funnel 100 may be received into the receiving container. In some examples, the lower section 106 may include one or more ribs which follow the exterior contour. These ribs may engage with an inlet of a receiving container and provide room for a gas inside of the receiving container to escape along an exterior surface of the funnel 100.

To facilitate venting of gas from a receiving container during filling, the lower section 106 and the outlet 118 may form a non-mating connection with a circular (or similar shape) container inlet so as to define one or more external vent channels. This external venting may prevent glugging and reduce turbulence, resulting in smoother transfer and higher net flow rates.

The funnel may be formed by injection molding, blow molding, or additive manufacturing using polymers such as polypropylene (PP), polyethylene (PE), polycarbonate (PC), or nylon. An inner surface of the tapered spiral section can include a hydrophobic coating (e.g., fluoropolymer or silicone-based) or a polished finish with an average roughness Ra between 0.1 micrometers (µm) and 2.0 µm to reduce static friction and adhesion for viscous liquids.

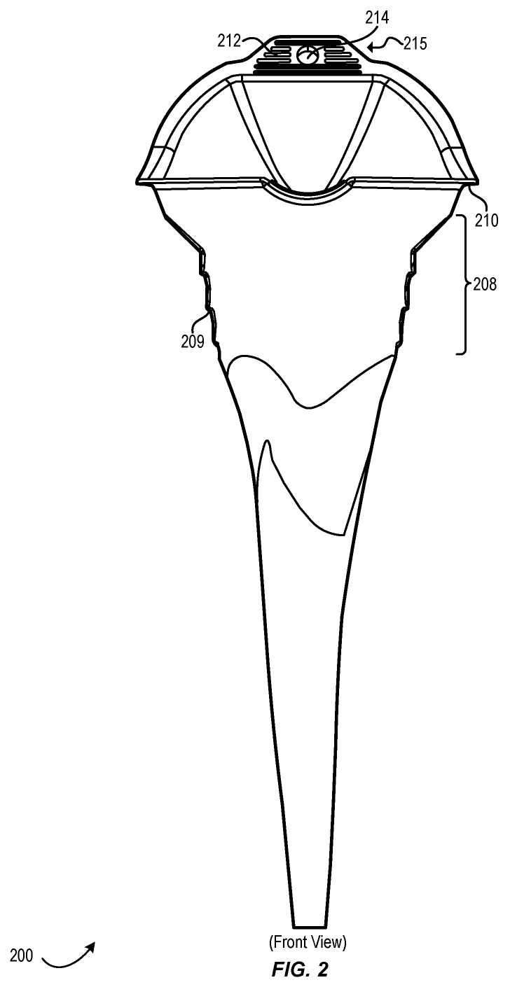

In various embodiments, the induced vortex funnel 100 may include colorants to aid measurements, identification, safety, and/or brand recognition. The upper section 102 or grip (described with respect to FIG. 2) can be colored using pigments or dyes suitable for the selected material and intended environment, including ultraviolet (UV) stable pigments for outdoor or industrial settings. Distinct colors can indicate size families or outlet geometries. For example, induced vortex funnels with a Reuleaux triangular outlet may be molded in red, while funnels with a Reuleaux pentagonal outlet are molded in blue to enable quick selection in multi-funnel environments. In laboratory embodiments, for example, translucent or semi-transparent materials can be used for the upper section to permit visual confirmation of fluid level during pouring. In one example, the upper section 102 may be molded in translucent polypropylene to allow users to see fluid swirling within the spiral 114, while the grip may be molded in opaque black elastomer for contrast and visual alignment cues.

In various embodiments, the induced vortex funnel 100 may include indicia disposed on an outer surface of the upper section 102 or proximate the upper edge to provide branding, instructions, volumetric graduations, or orientation cues. Indicia can be printed, laser-etched, molded-in, or applied as a durable label recessed within an indentation formed on the outer surface of the upper section. In some embodiments, the indicia include volumetric markings along the inner surface of the upper section 102 to indicate approximate fluid volume poured, with graduations corresponding to known cross-sectional area changes along the upper section. In another embodiment, an arrow or alignment mark indicates the location of a vertex of a constant-width outlet shape, enabling users to orient the outlet vertex with a seam or baffle within a receiving container. In one example, a molded recess on the outer surface includes a flat panel that receives a brand label and a QR code linking to digital instructions for use and cleaning.

In certain embodiments, the induced vortex funnel may include fiducial markers on the upper section or handle to facilitate machine vision recognition, automated handling, or quality control. Fiducial markers can include high-contrast dots, squares, or machine-readable codes, such as Data Matrix or QR codes, molded in relief or applied as durable ink, located within a recessed area to resist abrasion. In addition, the outer surface may include molded geometric features that serve as passive fiducials for structured-light scanners used in inspection of the spiral contour and outlet geometry during manufacturing. In one example, three evenly spaced circular fiducials may be molded into the upper edge and coded with distinct grayscale densities to allow robotic pick-and-place equipment to identify funnel orientation and align the outlet with a receiving container during automated filling operations.

FIG. 2 is a front view of an example induced vortex funnel 200, in accordance with various embodiments of the present disclosure. An upper section (e.g., upper section 102 as in FIG. 1) of the induced vortex funnel 200 may include an upper edge 210 which is flared away from the inlet (e.g., inlet 116). The upper section may include a grip 208 which includes a textured surface (e.g., patterned, coated, rough, etc.) that has one or more stair-shaped protrusions 209 that have a stair-shaped surface profile which includes a first end closer to the upper section and a second end farther from the upper surface relative to the first end. The stair-shaped profile may narrow between the first end and the second end. The grip 208 need not have a three-dimensional profile but may include a coating to help grip the induced vortex funnel 200. In some examples, the upper edge 210 may include a gripping surface 215 having at least one protrusion 212 and a hole 214 configured to receive a support mechanism (e.g., a hook).

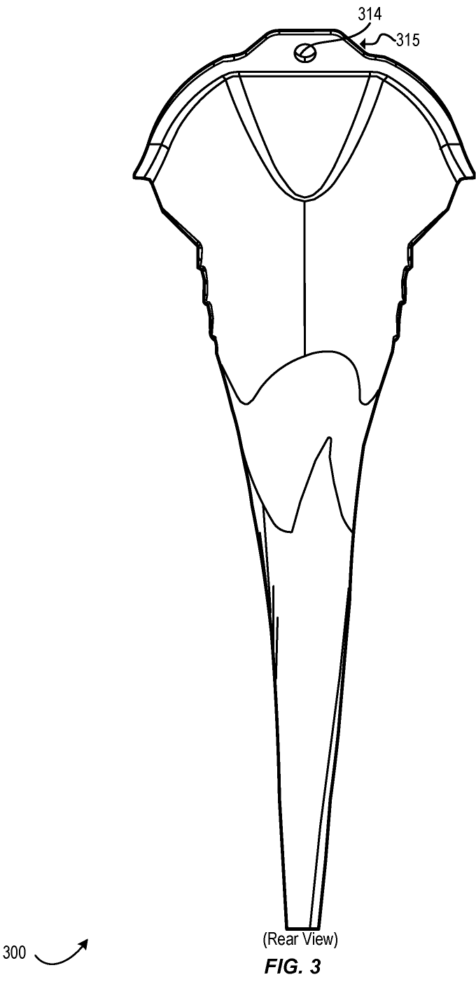

FIG. 3 is a rear view of an example induced vortex funnel 300, in accordance with various embodiments of the present disclosure. The induced vortex funnel 300 is an example of induced vortex funnel 100 as in FIG. 1. The induced vortex funnel 300 includes gripping surface 315 (an example of gripping surface 215) with a hole 314 configured to receive a support mechanism.

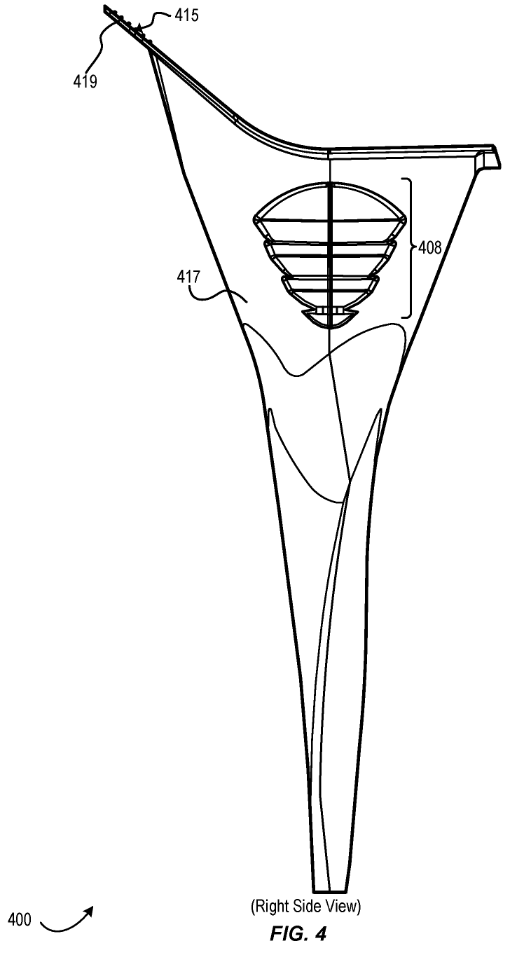

FIG. 4 is a right side view of an example induced vortex funnel 400, in accordance with various embodiments of the present disclosure. The induced vortex funnel 400 is an example of induced vortex funnel 100 as in FIG. 1. The induced vortex funnel 300 includes gripping surface 415 (an example of gripping surface 215) on a handle 419 and grip 408 on an outer surface 417. In various embodiments, the handle 419 may be coupled to the upper section, the handle 419 extending radially outward and upward at an angle between 1 degree and 90 degrees relative to a horizontal plane perpendicular to the outlet axis. The handle 419 may include the gripping surface 415 and/or a hook-receiving aperture for hanging storage. The handle 419 can be integrally molded with the upper section or attached via fasteners.

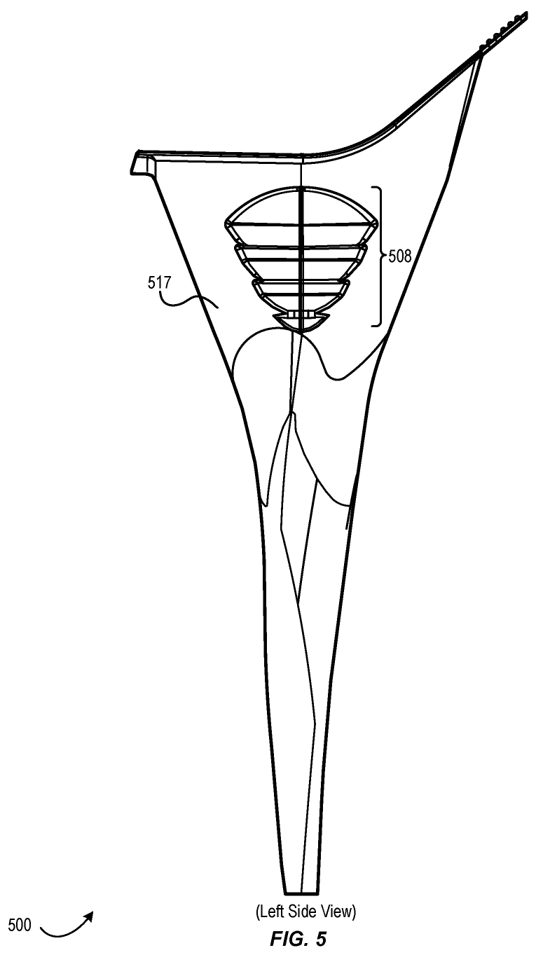

FIG. 5 is a left side view of an example induced vortex funnel 500, in accordance with various embodiments of the present disclosure. The induced vortex funnel 500 is an example of induced vortex funnel 100 as in FIG. 1. Similar to FIG. 4, the induced vortex funnel 500 may include a grip 508 on an outer surface 517. While the grips 408, 508 are illustrated on either side of the induced vortex funnels 400, 500, it should not be considered limiting and one or both grips 408, 508 may be options. In addition, or alternatively, the grips 408, 508 may extend around an entirety or portion of an outer circumference of the outer surfaces 417, 517.

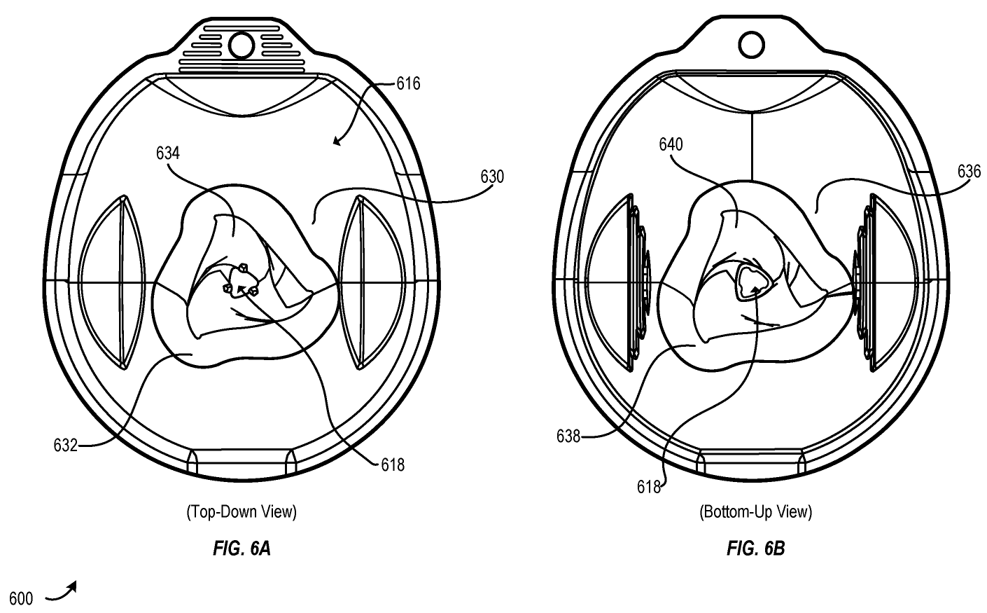

FIG. 6A is a top-down view of an example induced vortex funnel 600, in accordance with various embodiments of the present disclosure. The induced vortex funnel 600 is shown from a top-down view showing the viewpoint of a conduit extending between an inlet 616 and an outlet 618. The induced vortex funnel 600 includes a tapered spiral section including three illustrated spiraled sections 630, 632, 634 on an inner surface which define a first spiral surface profile from the inlet 616 to the outlet 618. While three spiraled sections 630, 632, 634 are depicted for clarity of discussion, it should not be considered limiting, and any suitable spiral, helix, vortex, may be implemented including any suitable amount of “turns” between the inlet 616 and outlet 618. In some examples, a rotating surface contour on an outer surface of the induced vortex funnel 600 may overlap with an inner surface, or may be out of phase with one another such that the outer surface includes a surface contour that does not overlap with the inner surface to aid in preventing stacks of funnels from getting stuck together since the outer surface of a first funnel will not be able to mate with an inner surface of a second funnel.

FIG. 6B is a bottom-up view of an example induced vortex funnel 600, in accordance with various embodiments of the present disclosure. The induced vortex funnel 600 is shown from a bottom-up view showing the view point of the outlet 618. The induced vortex funnel 600 includes a tapered spiral section including three illustrated spiraled sections 636, 638, 640 on an outer surface which define a second spiral surface profile from the inlet 616 to the outlet 618. While three spiraled sections 636, 638, 640 are depicted for clarity of discussion, it should not be considered limiting, and any suitable spiral, helix, vortex, may be implemented including any suitable amount of “turns” between the inlet 616 and outlet 618. In some examples, the first spiral surface profile may match the second spiral surface profile. In some examples, the first spiral surface profile may have a different spiral profile than the second spiral surface profile. In various embodiments, the second spiral surface profile may be optional. A tapered spiral surface may be defined by the spiraled sections. In addition, or alternatively, the tapered spiral surface may be defined as an internal rib, a geometric shape with constant width (e.g., a pentagon), or a geometric shape with dynamic width (e.g., a Reuleaux pentagon). Tapered spiral surface may be a geometric shape (e.g., cone) with a spiral rib going along the inner surface and/or the outer surface.

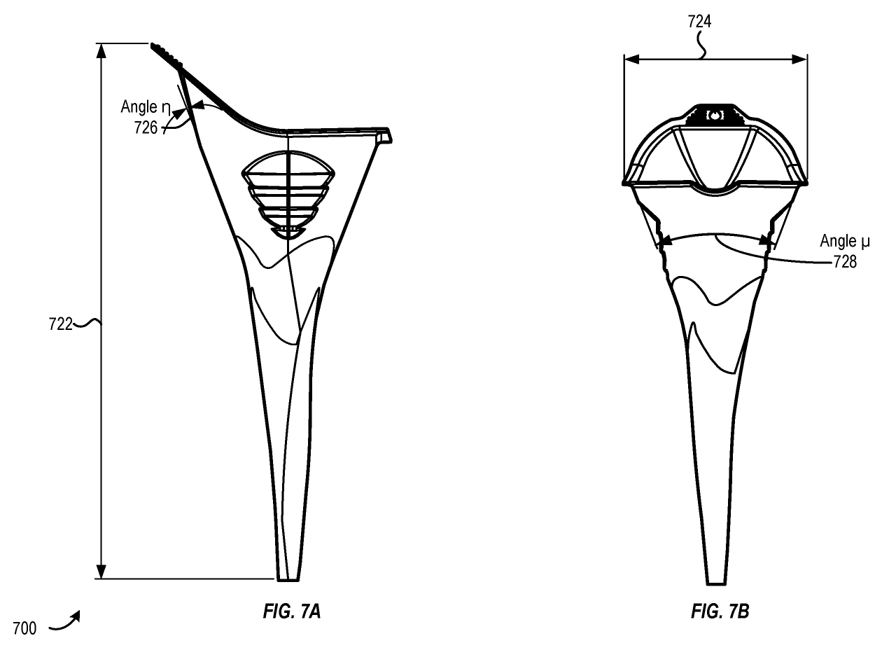

FIG. 7A depicts a configuration of an example induced vortex funnel 700, in accordance with various embodiments of the present disclosure. The induced vortex funnel 700 is shown with an upper section gripping section angled with respect to a tapered spiral section at an angle ƞ. The angle ƞ may be between zero degrees and one hundred and eighty degrees relative to a horizontal axis parallel to an outlet of the induced vortex funnel 700. The induced vortex funnel 700 may include a height 722 between three inches and two feet.

FIG. 7B depicts a configuration for an example induced vortex funnel, in accordance with various embodiments of the present disclosure. The induced vortex funnel 700 is shown with an upper section gripping diameter angled with respect to a tapered spiral section at an angle µ. The angle µ may be between zero degrees and one hundred and eighty degrees relative to a horizontal axis parallel to an outlet of the induced vortex funnel 700. The induced vortex funnel 700 may include a width 724 between three inches and two feet.

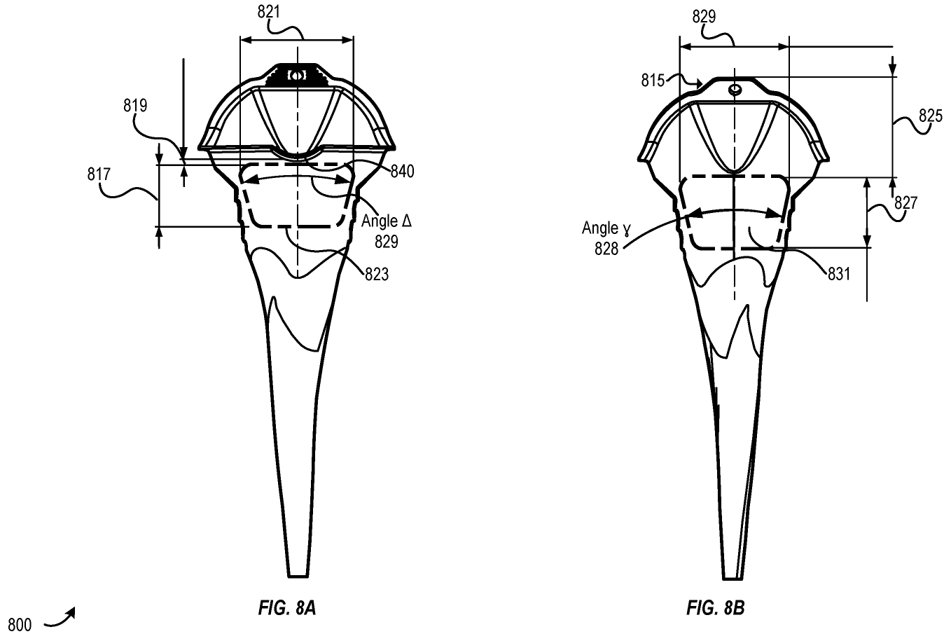

FIG. 8A depicts a configuration for an example gripping surface for an induced vortex funnel 800, in accordance with various embodiments of the present disclosure. FIG. 8A depicts a front view of the induced vortex funnel 800 which includes a surface 823 capable of receiving an advertisement (e.g., logo, brand, trademark, etc.). The surface 823 may include an indentation configured to receive an attachment (e.g., sticker) and, due to the cylindrical nature of the induced vortex funnel 800, may include an angular profile with angle Δ 829 (e.g., thirty degrees). The surface may have a width 821 between half an inch and six inches. A height 817 of the surface 823 may be between half an inch and six inches and be spaced from a contoured indentation 840 by a distance 819 between 0.01 inches and two inches.

FIG. 8B depicts a configuration for an example gripping surface for an induced vortex funnel, in accordance with various embodiments of the present disclosure. FIG. 8B depicts a rear view of the induced vortex funnel 800 which includes a surface 831 capable of receiving an advertisement (e.g., logo, brand, trademark, etc.). The surface 831 may include an indentation configured to receive an attachment (e.g., sticker) and, due to the cylindrical nature of the induced vortex funnel 800, may include an angular profile with angle ɣ 828 (e.g., thirty degrees). A height 827 of the surface may be between half an inch and six inches and be spaced from a gripping surface 815 by a distance 825 between 0.01 inches and ten inches. The surface may have a width 829 between half an inch and six inches.

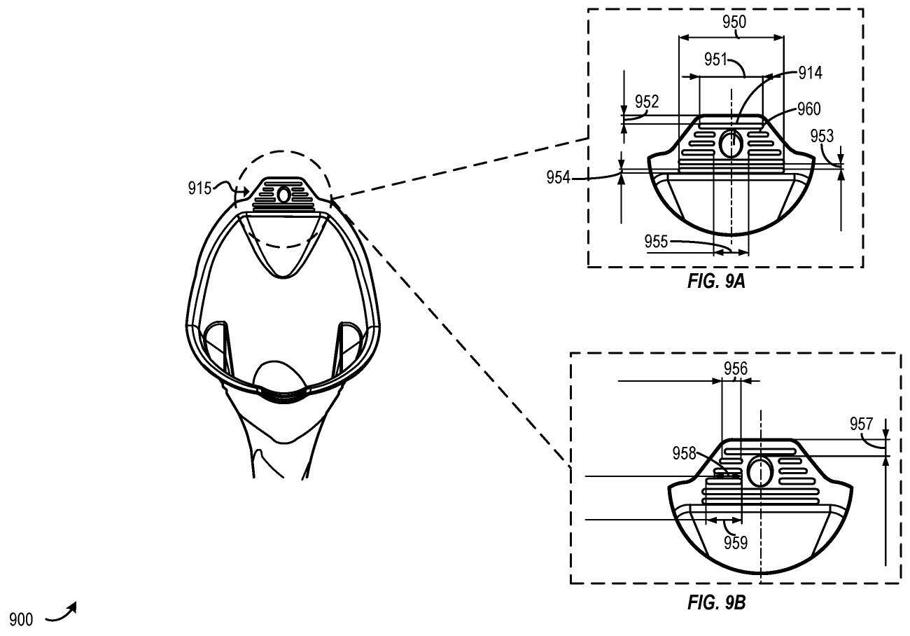

FIGS. 9A and 9B depicts a configuration of an example induced vortex funnel 900, in accordance with various embodiments of the present disclosure. The induced vortex funnel 900 includes a gripping surface 915 which includes one or more protrusions 960. The protrusions 960 may be bumps which extend from the gripping surface 915 to provide a surface which is readily grasped by a user. Example dimensions for the protrusions 960 are shown but should not be considered limiting. For example, widths 950, 951, 955, 956, 959, 958, may be between 0.1 inch and six inches. Heights 952, 953, 954, 957 may be between 0.1 inch and six inches.

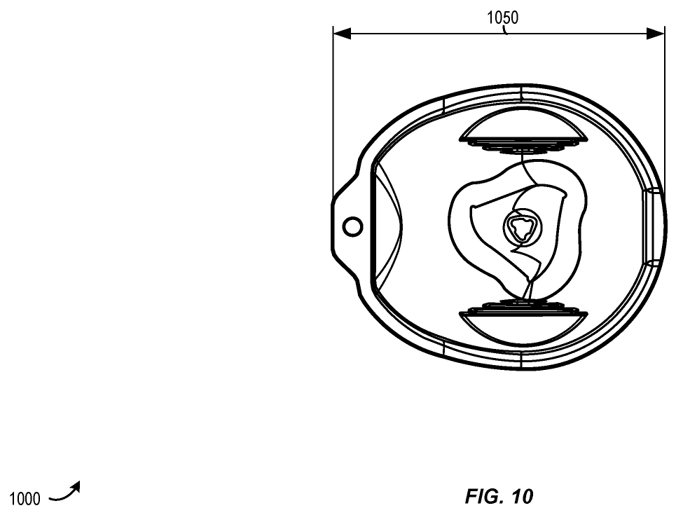

FIG. 10 depicts a configuration for an example induced vortex funnel 1000, in accordance with various embodiments of the present disclosure. The induced vortex funnel 1000, shown from a bottom view with an exterior surface in view, may have a diameter 1050 between three inches and two feet. In various embodiments, the diameter 1050 can be larger than two feet or smaller than three inches.

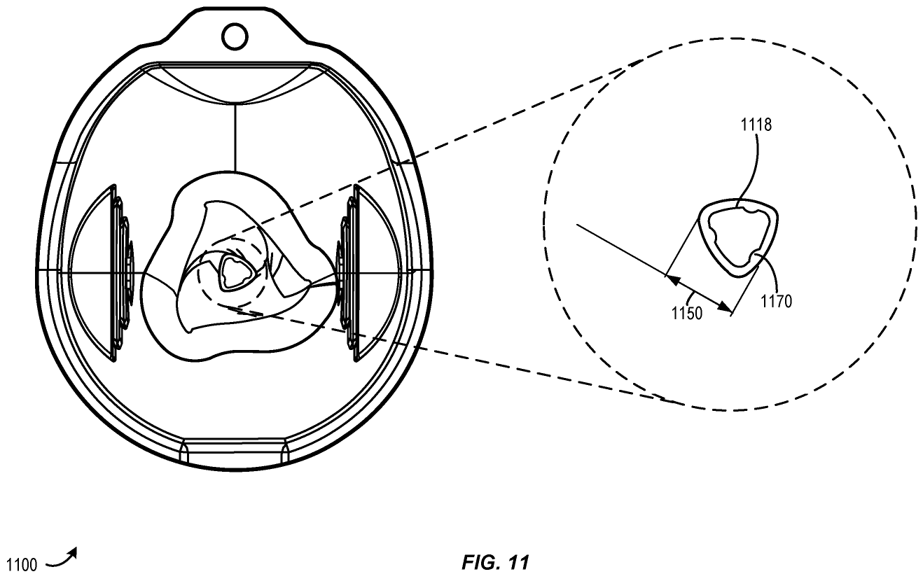

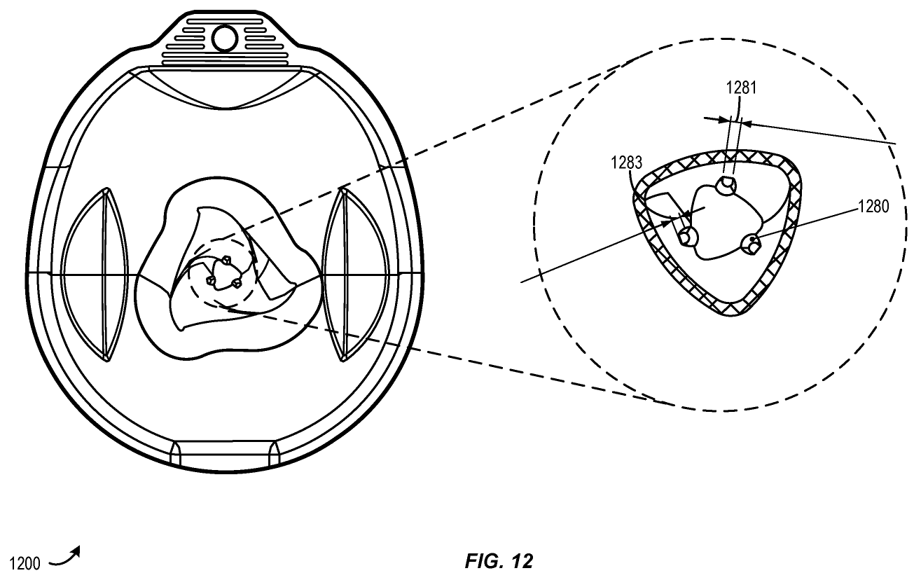

FIG. 11 depicts a configuration for a non-circular shaped outlet of an example induced vortex funnel 1100, in accordance with various embodiments of the present disclosure. The induced vortex funnel 1100 includes an outlet 1118 in a non-circular configuration. In this example, the outlet 1118 includes a triangular shaped outlet (e.g., Reuleaux shaped) with a protrusions 1170 which are a far end of ribs (not depicted, ribs 1280 with respect to FIG. 12). The protrusions 1170 may promote liquid flow out of the induced vortex funnel 1100. The outlet 1118 may have a width between 0.5 inch and six inches. In examples where the outlet is Reuleaux shaped, the sides of the Reuleaux triangle may be convex or concave. In additive manufacturing embodiments, the spiral ribs and cross-sections can be produced with a layer height between 0.1 millimeters (mm) and 0.3mm to maintain smooth flow channels.

FIG. 12 depicts a configuration for ribs of an example induced vortex funnel 1200, in accordance with various embodiments of the present disclosure. Induced vortex funnel 1200 may include at least one rib 1280. The ribs 1280 may serve a variety of functions. For example, the ribs 1280 may permit stacking of additional induced vortex funnels within each other such that an outer surface of a lower section (e.g., lower section 106 with respect to FIG. 1) can be supported by the ribs 1280 of an inner area of the lower section without compressing causing the induced vortex funnels getting stuck together. In addition, or alternatively, the ribs 1280 may promote vortex flow within the induced vortex funnel 1200 by mitigating fluid cross-talk along different helical curves. In some examples, the induced vortex funnel 1200 may include two or more (e.g., three, four, five, etc.) ribs 1280. The ribs 1280 may include a width 1281 and a thickness 1283 between 0.1 inch and one inch. In some examples the ribs 1280 may be textured.

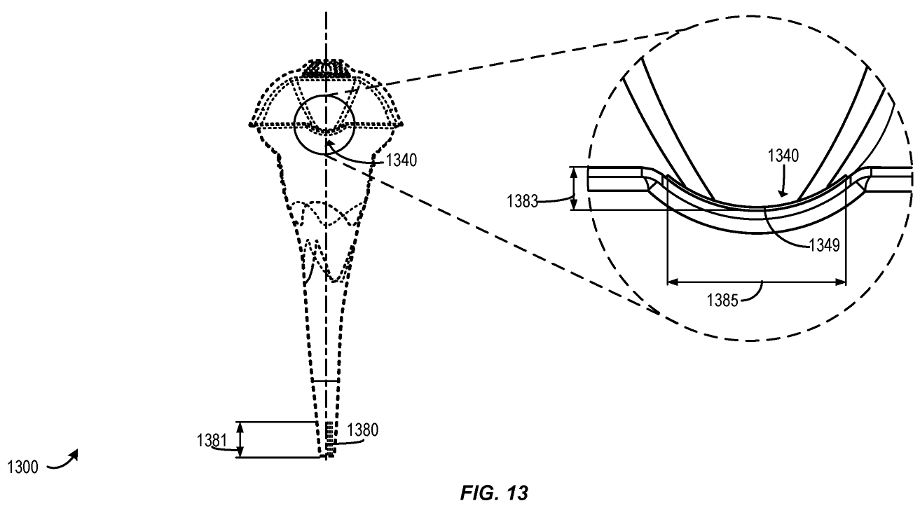

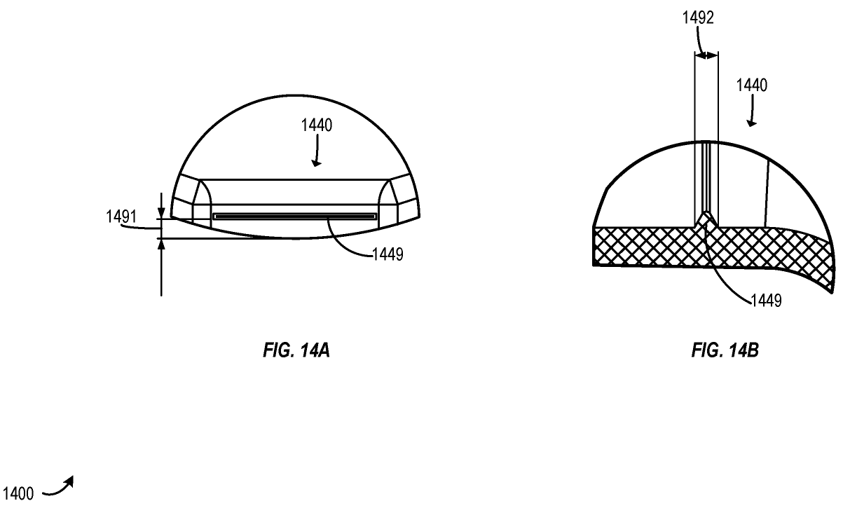

FIG. 13 depicts a configuration for a contoured indentation of an example induced vortex funnel 1300, in accordance with various embodiments of the present disclosure. The induced vortex funnel 1300 may include a contoured indentation 1340 with a protruding lip 1349. The protruding lip 1349 will be discussed in more detail with respect to FIGS. 14A and 14B. The contoured indentation 1340 may include a width 1385 between one inch and six inches and a height 1383 between 0.25 inches and four inches. The induced vortex funnel 1300 may include one or more ribs 1380, shown as dashed lines within a transparent view of the induced vortex funnel 1300. The ribs 1380 may follow a spiral contour on an inner surface of the induced vortex funnel 1300 and include a height 1381 between 0.5 inches and two feet. The ribs 1380 may extend from an outlet to an inlet of the induced vortex funnel 1300. The spiral contour may include a rotation between -1080 degrees and 1080 degrees relative to a central axis of the induced vortex funnel 1300. In addition, or alternatively, a second set of rubs (not depicted, but similar in structure to ribs 1380) may exist on an exterior surface of the funnel 1300 to at least partially engage with a surface of an inlet of a receiving container to enable gas (e.g., air) to flow from the receiving container as fluid from the funnel 1300 fills the receiving container. The engagement may be dissimilar to provide one or more spaces between the inlet of the receiving container and the funnel 1300.

FIGS. 14A and 14B depicts a configuration for a protruding lip of an example induced vortex funnel 1400, in accordance with various embodiments of the present disclosure. The induced vortex funnel 1400 may include protruding lip 1449 which may be spaced from an edge of a contoured indentation 1440 by a distance 1491 between 0.1 and two inches. The protruding lip 1449 may have a height between 0.1 and two inches and a width 1492 between 0.1 and two inches.

FIG. 15 depicts a configuration for a parting line of an example induced vortex funnel 1500, in accordance with various embodiments of the present disclosure. For example, one or more parting lines 1512 along an outside of the induced vortex funnel may allow the funnels to be stacked without compaction that would make it difficult for users to remove funnels from one another. The parting line 1512 may enable ease of removal of funnels from the stacks since the parting line 1512 is not linearly positioned (e.g., not straight up and down along the induced vortex funnel. For example, using an asymmetric parting line as depicted promotes funnel stacking in that, when stacked together, each subsequent induced vortex funnel will be positioned slightly higher such that the asymmetric parting line will not have a complementary fit with the support induced vortex funnel. The parting line 1512 which is/on the induced vortex funnel 1500 may be formed together and/or split apart. The induced vortex funnel 1500 may include attachment mechanisms in order to hold the induced vortex funnel 1500 together. In some examples, the induced vortex funnel 1500 may be mold (e.g., melted) fitted together along the parting line 1512. While only a single parting line 152 is depicted, it should not be considered limiting and any suitable number of parting lines may be included. The parting lines do not necessarily need to be positioned from end to end vertically but rather can follow various configurations that optimize forming the induced vortex funnels. For example, it may be beneficial to mass manufacture an upper section of the induced vortex funnel with the same size and shape of the bowl and, separately, manufacture different shapes and sizes of the tapered spiral section of the funnel for various applications. In this manner, the parting line would be horizontally across and formed at an intersection of the upper section and the tapered spiral section.

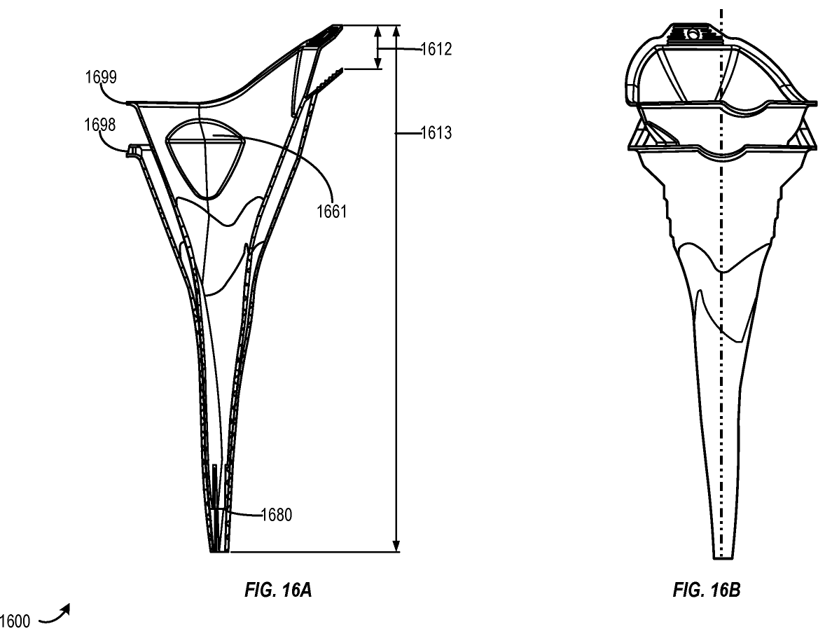

FIG. 16A depicts a cross-section stacked example induced vortex funnels 1699, 1698, in accordance with various embodiments of the present disclosure. In this example, multiple induced vortex funnels may be stacked together. A support protrusion 1661 on an inner surface (or outer surface) may function to support addition funnels at a height 1612 between 0.1 inches and three inches. In addition, or alternatively, ribs near an outlet of the funnels may include a support surface 1680 that supports an outlet of an addition induced vortex funnel. A stack height 1613 for two funnels may include the height of one induced vortex funnel plus the height 1612. The stack height may scale for each additional funnel by the height 1612. The support protrusion 1661 and support surface 1680 may be substantially flat relative to a horizontal plane parallel to the outlet. This structure mitigates stacked funnels from getting stuck together. For example, if a user (or machine) were to force a top funnel into a bottom funnel, the lower portions would continue to get tighter the harder the top one is pushed. The support protrusion 1661 and support surface 1680 may prevent this by arresting further movement.

FIG. 16B depicts an external view for stacking example induced vortex funnels, in accordance with various embodiments of the present disclosure. By way of a non-limiting example, the induced vortex funnels includes features that facilitate stackability without compaction to enable multiple induced vortex funnels to be nested and readily separated. The upper section can comprise an inner surface having at least one support protrusion configured to resist and/or stop downward movement of another, induced vortex funnel received within the upper section. In some embodiments, the support protrusion provides a substantially planar support surface that is flat within a degree range (e.g., between -90 and 90) relative to a plane perpendicular to an outlet axis, and that is positioned a height (e.g., between 0.1 inch and 24 inches) above the outlet. In various embodiments, the lower section includes one or more ribs that terminate at or proximate to the outlet and further present a local support surface. When a second induced vortex funnel is stacked into a first induced vortex funnel, the outlet perimeter or rib shoulder of the second funnel engages the support surface of the first funnel, preventing compaction and frictional wedging. In a non-limiting example, a induced vortex funnel having an overall height of 7.5 inches includes an inner support protrusion at 1.2 inches above the outlet and a rib shoulder at 0.25 inch above the outlet, together setting a repeatable stack height increment of approximately 1.2 inches for each additional funnel.

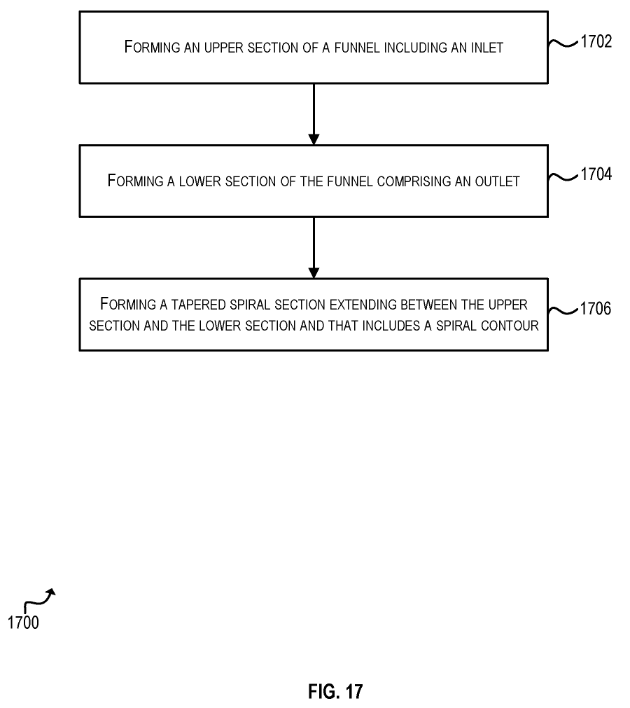

FIG. 17 depicts an example method for forming funnels, in accordance with various embodiments of the present disclosure. It should be appreciated that the operations of the method 1700 may be performed in any suitable order, not necessarily the order depicted in FIG. 17. Further, the method 1700 may include additional, or fewer operations than those depicted in FIG. 17. The operations of method 1700 may be performed by any suitable portion of the manufacturing technique.

At block 1702, the method 1700 may include forming an upper section of a funnel including an inlet. By way of a non-limiting example, the upper section (e.g., upper section 102 with respect to FIG. 1) of the funnel may include the inlet configured to receive fluids in the shape of a circle, frustoconical opening, or suitable equivalent. Forming the upper section may be done using any suitable manufacturing processing. For example, the upper section may be formed by 3D printing, injection molding, blow molding, vacuum forming, compression molding, and suitable equivalents. The upper section may be formed of any suitable material that may be bonded, welded, fastened, and/or adhered together.

At block 1704, the method 1700 may include forming a lower section of the funnel comprising an outlet. By way of a non-limiting example, the lower section (e.g., lower section 106 with respect to FIG. 1) of the funnel may include the outlet configured to expel fluids in the shape of a circle, Reuleaux triangle, or suitable equivalent. Forming the lower section may be done using any suitable manufacturing processing. For example, the upper section may be formed by 3D printing, injection molding, blow molding, vacuum forming, compression molding, and suitable equivalents. The lower section may be formed of any suitable material that may be bonded, welded, fastened, and/or adhered together.

At block 1706, the method 1700 may include forming a tapered spiral section extending between the upper section and the lower section that includes a spiral contour. By way of a non-limiting example, the tapered spiral section (e.g., tapered spiral section 104 with respect to FIG. 1) of the funnel may be coupled to the inlet of the upper section and the outlet of the lower section and be configured to cause rotation of fluid therein when the fluid comes in contact with the spiral contour. Forming the tapered spiral section may be done using any suitable manufacturing processing. For example, the tapered spiral section may be formed by 3D printing, injection molding, blow molding, vacuum forming, compression molding, and suitable equivalents. The tapered spiral section may be formed of any suitable material that may be bonded, welded, fastened, and/or adhered together. In some examples, the upper section, tapered spiral section, and lower section may be formed together as a unitary object or may be put together using methods described herein in a piecewise manner (e.g., using the parting line 1512 with respect to FIG. 15).

In various embodiments, the induced vortex funnel may be configured for use with an optional adapter to expand compatibility with different specialized (e.g., proprietary inlets) receiving container inlets while preserving venting and induced vortex funnel performance. An adapter can be removably coupled to the lower section and can include a collar or sleeve configured to interface with the non-circular outlet while presenting a modified external profile. In certain embodiments, the adapter may include a generally circular outer interface for narrow bottle necks and includes internal spacers or ribs that contact the induced vortex funnel’s lower section at discrete locations to maintain one or more external vent channels for gas escape. In various embodiments, a compliant adapter gasket may be formed from silicone or thermoplastic elastomer to engage a perimeter of a Reuleaux triangular outlet via snap features, while the gasket’s outer surface includes longitudinal grooves that sustains venting when the adapter is received within a circular inlet of a receiving container. In one example, an adapter ring having a circular outer diameter and four equi-spaced longitudinal grooves may provide a maintained vent channel cross-sectional area to reduce back-pressure and preventing glugging.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein. Variations of those preferred examples may become apparent to those of ordinary skill in the art upon reading the foregoing description. Accordingly, this disclosure includes all modifications and equivalents of the subject matter. Moreover, any combination of the above-described elements in all possible variations thereof is encompassed by the disclosure unless otherwise indicated herein or otherwise clearly contradicted by context.

Example 1: A funnel comprising an upper section including an inlet configured to receive a liquid; a lower section including an outlet configured to expel the liquid; and a tapered spiral section extending between the upper section and the lower section which includes a spiral contour configured to rotate the liquid from the inlet to the outlet.

Example 2: The funnel of Example 1, wherein a shape of the outlet and the spiral contour are a same shape.

Example 3: The funnel according to any preceding examples, wherein the outlet is a triangular shaped outlet.

Example 4: The funnel according to any preceding examples, wherein the outlet is a Reuleaux triangle.

Example 5: The funnel according to any preceding examples, wherein the spiral contour includes one or more convex contours or one or more concave contours.

Example 6: The funnel according to any preceding examples, wherein the tapered spiral section comprises an inner surface and an outer surface which collectively define the spiral contour.

Example 7: The funnel according to any preceding examples, wherein the inner surface includes a first spiral surface profile which begins at the upper section and ends at the lower section.

Example 8: The funnel according to any preceding examples, wherein the outer surface includes a second spiral surface profile which begins at the upper section and ends at the lower section, wherein the first spiral surface profile substantially matches the second spiral surface profile.

Example 9: The funnel according to any preceding examples, wherein one or more ribs follow the spiral contour and terminate at one or more sides of the outlet.

Example 10: The funnel according to any preceding examples, wherein one or more ribs follow the spiral contour and terminate at one or more corners of the outlet.

Example 11: The funnel according to any preceding examples, wherein the upper section further comprises an upper edge which flares away from the inlet.

Example 12: The funnel according to any preceding examples, wherein the upper edge comprises: a gripping surface having at least one protrusion.

Example 13: The funnel according to any preceding examples, wherein the gripping surface includes a hole.

Example 14: The funnel according to any preceding examples, wherein the upper edge includes a contoured indentation with a protruding lip, the contoured indentation being indented towards the lower section.

Example 15: The funnel according to any preceding examples, wherein the upper section comprises an outer surface which includes at least one grip.

Example 16: The funnel according to any preceding examples, wherein the at least one grip includes a textured surface.

Example 17: The funnel according to any preceding examples, wherein the textured surface has a stair-shaped surface profile.

Example 18: The funnel according to any preceding examples, wherein the stair-shaped surface profile includes a first end closer to the upper section and a second end farther from the upper section relative to the first end, the stair-shaped surface profile narrows between the first end and the second end.

Example 19: The funnel according to any preceding examples, wherein the upper section comprises an inner surface with at least one support protrusion, the at least one support protrusion is defined at least in part by at least a portion of the at least one grip which extends into the inner surface.

Example 20: The funnel according to any preceding examples, wherein the inner surface includes at least one rib.

Example 21: The funnel according to any preceding examples, wherein the at least one rib includes a first end and a second end, the first end including a support surface configured to support at least a portion of a second funnel and the second end terminating at the outlet.

Example 22: The funnel according to any preceding examples, wherein the at least one rib extends along the inner surface of the tapered spiral section and curves along the spiral contour.

Example 23: The funnel according to any preceding examples, wherein the support surface is substantially flat.

Example 24: The funnel according to any preceding examples, wherein the spiral contour includes a rotation between -1080 degrees and 1080 degrees with respect to the upper section.

Example 25: The funnel according to any preceding examples, wherein the inlet is wider than the outlet.

Example 26: The funnel of Example 1, wherein a cross-sectional shape of the tapered spiral section adjacent the outlet is the same constant-width curve as a cross-sectional shape of the outlet.

Example 27: The funnel according to any preceding examples, wherein one or more ribs follow the spiral contour and terminate at one or more vertices of the outlet.

Example 28: The funnel according to any preceding examples, wherein the stair-shaped surface profile includes a first end closer to the upper section and a second end farther from the upper section relative to the first end, the stair-shaped surface profile narrows between the first end and the second end.

Example 29: The funnel according to any preceding examples, wherein the spiral contour includes a rotation between 90 degrees and 1080 degrees about a central longitudinal axis.

Example 30: The funnel according to any preceding examples, wherein the lower section and outlet define, when engaged with a circular inlet of a receiving container, at least one external vent channel between the outlet and the circular inlet configured to allow gas to escape from the receiving container while liquid is dispensed.

Example 31: The funnel according to any preceding examples, wherein the external vent channel is formed at least in part by one or more ribs on an outer surface of the lower section proximate the outlet.

Example 32: The funnel according to any preceding examples, wherein each rib has a height between 0.05 inch and 0.3 inch and a thickness between 0.05 inch and 0.2 inch.

Example 33: The funnel according to any preceding examples, wherein an inner surface of the tapered spiral section has an average roughness Ra between 0.1μm and 2.0μm.

Example 34: The funnel according to any preceding examples, wherein a cross-sectional shape of the tapered spiral section is a variable-width curve selected from the group consisting of a Reuleaux triangle, a Reuleaux pentagon, and a rounded polygonal constant-width curve.

Example 35: The funnel according to any preceding examples, wherein a ratio of inlet width to outlet width is between 1.2 and 10.

Example 36: The funnel according to any preceding examples, further comprising a handle attached to the upper section, the handle extending at an angle between 20 degrees and 60 degrees relative to a plane perpendicular to an outlet axis, the handle including a hook-receiving aperture.

Example 37: The funnel according to any preceding examples, wherein the support surface is flat within ±2 degrees relative to a plane perpendicular to an outlet axis.

Example 38: A funnel comprising an upper section including an inlet; a lower section including a non-circular outlet; a tapered spiral section between the upper section and the lower section; and one or more exterior ribs proximate the outlet configured to form, when the outlet engages a circular inlet of a receiving container, at least one external vent channel that permits gas to escape from the receiving container while liquid is dispensed through the outlet.

Example 39: A method of transferring a liquid into a receiving container, the method comprising positioning a funnel having a tapered spiral section and a non-circular outlet at an inlet of the receiving container; pouring the liquid into the inlet of the funnel; inducing vortical motion of the liquid along the tapered spiral section of the funnel; and simultaneously venting gas from the receiving container along an exterior surface of the funnel through at least one external vent channel while expelling the liquid through the non-circular outlet.

Example 40: A conduit comprising an inlet; an outlet; and a connecting body extending between the inlet and the outlet, wherein at least a portion of the connecting body is rotated with respect to at least one of the inlet or the outlet.

Example 41: The conduit or funnel according to any preceding examples, further comprising: one or more ribs curve to match the connecting body and terminate at the outlet.

Example 42: The conduit or funnel according to any preceding examples, wherein the inlet further comprises an edge which flares away from the inlet.

Example 43: The conduit or funnel according to any preceding examples, wherein edge comprises: a gripping surface having at least one protrusion.

Example 44: The conduit or funnel according to any preceding examples, wherein the gripping surface includes a hole.

Example 45: The conduit or funnel according to any preceding examples, wherein the edge includes a contoured indentation with a protruding lip, the contoured indentation being indented towards the outlet.

Example 46: The conduit or funnel according to any preceding examples, wherein the inlet comprises an outer surface which includes at least one grip.

Example 47: The conduit or funnel according to any preceding examples, wherein the at least one grip includes a textured surface.

Example 48: The conduit or funnel according to any preceding examples, further comprising: one or more support protrusions positioned i) within the connecting body, ii) outside of the connecting body, or both i) and ii) configured to provide a supporting surface for at least a portion of a second conduit to be at least partially positioned within the connecting body.

Example 49: The conduit or funnel according to any preceding examples, further comprising: an asymmetric parting line positioned along the connecting body.

Example 50: A method comprising forming an upper section of a funnel including an inlet; forming a lower section of the funnel comprising an outlet; and forming a tapered spiral section extending between the upper section and the lower section and that includes a spiral contour.

All references, including publications, patent applications, and patents, cited herein are hereby incorporated by reference to the same extent as if each reference were individually and specifically indicated to be incorporated by reference and were set forth in its entirety herein.

Unless expressly stated otherwise, any feature, option, parameter, or characteristic described in connection with any embodiment or Example is compatible with and may be combined with any other disclosed feature, option, parameter, or characteristic, and such combinations are deemed disclosed whether or not expressly depicted together. References to particular embodiments or Examples do not imply mutual exclusivity, and features recited in dependent Examples or claims are optional unless stated to be essential. Alternatives may be selected and interchanged across embodiments to suit specific applications; disclosed ranges include endpoints and subranges; and directional or orientational terms are used for descriptive convenience only and do not limit implementation.

What is claimed is:

1. A funnel comprising:
an upper section including an inlet configured to receive a liquid;
a lower section including an outlet configured to expel the liquid; and
a tapered spiral section extending between the upper section and the lower section that includes a spiral contour configured to rotate the liquid from the inlet to the outlet.

2. The funnel of claim 1, wherein a first shape of the outlet corresponds to a second shape of the spiral contour.

3. The funnel of claim 2, wherein the outlet is a triangular shaped outlet.

4. The funnel of claim 2, wherein the outlet is a Reuleaux triangle.

5. The funnel of claim 1, wherein the spiral contour includes one or more convex contours or one or more concave contours.

6. The funnel of claim 1, wherein the tapered spiral section comprises an inner surface and an outer surface which collectively define the spiral contour.

7. The funnel of claim 6, wherein:
i) the inner surface includes a first spiral surface profile that begins at the upper section and ends at the lower section, or
ii) the inner surface includes the first spiral surface profile that only spatially overlaps with the tapered spiral section.

8. The funnel of claim 7, wherein:
i) the outer surface includes a second spiral surface profile which begins at the upper section and ends at the lower section, wherein the first spiral surface profile substantially matches the second spiral surface profile, or
ii) the outer surface includes the second spiral surface profile that only spatially overlaps with the tapered spiral section, wherein the first spiral surface profile substantially matches the second spiral surface profile.

9. The funnel of claim 1, wherein one or more ribs curve to match the spiral contour and terminate at one or more sides of the outlet.

10. A conduit comprising:
an inlet;
an outlet; and
a connecting body extending between the inlet and the outlet, wherein at least a portion of the connecting body is rotated with respect to at least one of the inlet or the outlet.

11. The conduit of claim 10, further comprising:
one or more ribs curved to match the connecting body and terminate at the outlet.

12. The conduit of claim 10, wherein the inlet further comprises an edge which flares away from the inlet.

13. The conduit of claim 12, wherein the edge comprises: a gripping surface having at least one protrusion.

14. The conduit of claim 13, wherein the gripping surface includes a hole.

15. The conduit of claim 12, wherein the edge includes a contoured indentation with a protruding lip, the contoured indentation being indented towards the outlet.

16. The conduit of claim 10, wherein the inlet comprises an outer surface which includes at least one grip.

17. The conduit of claim 16, wherein the at least one grip includes a textured surface.

18. The conduit of claim 10, further comprising: one or more support protrusions positioned i) within the connecting body, ii) outside of the connecting body, or both i) and ii) configured to provide a supporting surface for at least a portion of a second conduit to be at least partially positioned within the connecting body.

19. The conduit of claim 10, further comprising:
an asymmetric parting line positioned along the connecting body.

20. A method comprising:
forming an upper section of a funnel including an inlet;
forming a lower section of the funnel comprising an outlet; and
forming a tapered spiral section extending between the upper section and the lower section and that includes a spiral contour.
